(19) United States
(12) Patent Application Publication
(10) Pub. No.: US 2015/0046863 A1
(43) Pub. Date: Feb. 12, 2015

(54) INFORMATION PROCESSING METHOD AND ELECTRONIC DEVICE

(71) Applicant: Lenovo (Beijing) Limited, Beijing (CN)

(72) Inventor: Xu Zhao, Beijing (CN)

(73) Assignee: Lenovo (Beijing) Limited, Beijing (CN)

(21) Appl. No.: 14/220,504

(22) Filed: Mar. 20, 2014

(30) Foreign Application Priority Data
Aug. 9, 2013 (CN) 201310347027.3

(51) Int. Cl. G06F 3/0484

(52) U.S. Cl. CPC G06F 3/04847
USPC 715/771

(57) ABSTRACT

The present invention discloses information processing methods and electronic devices. The method comprises: displaying an operation control for activating a first functional module on a display unit of the electronic device; activating, by the electronic device, the first functional module in response to an operating trigger for the operation control upon obtaining a first input operation on the operation control; and activating, by the electronic device, the first functional module in response to a timing trigger for the operation control upon obtaining a second input operation on the operation control. The first input operation is different from the second input operation. With the solutions of the present invention, the setting steps of an application can be simplified, thereby saving time and labor, and the time countdown of the application can be displayed to a user.

### TECHNICAL FIELD

The present invention relates to information processing technology, and more particularly, to information processing methods and electronic devices.

### BACKGROUND

Currently, electronics devices such as Personal Computers (PCs), smart phones, Personal Digital Assistants (PDAs) have become popular with users because of their multiple functions. These electronic devices are provided with photographing functions. When a photographing function is used, several mode selection keys are provided on a mode selection interface for the photographing function. After a user clicks his/her desired mode selection key, a photographing interface is entered and the user needs to click again a photographing function key on the photographing interface for photographing. That is, the existing photographing function typically requires several setting steps. For a user who uses the photographing function for the first time, such setting process is troublesome, time- and labor-consuming. Further, for an electronic device having a built-in countdown photographing function, time countdown is performed only in background of the electronic device, but is not displayed to a user. Hence, the user is unaware of the specific time at which the photographing operation will occur, and may be photographed when he/she is not ready yet.

### SUMMARY

It is an object of the present invention to provide an information processing method and an electronic device capable of simplifying setting operations for a photographing or playing application, saving time and labor, and displaying time countdown for the photographing or playing application.

In order to achieve the above object, an embodiment of the present invention provides an information processing method. The information processing method in an electronic device comprises: displaying an operation control for activating a first functional module on a display unit of the electronic device; activating, by the electronic device, the first functional module in response to an operating trigger for the operation control upon obtaining a first input operation on the operation control; and activating, by the electronic device, the first functional module in response to a timing trigger for the operation control upon obtaining a second input operation on the operation control. The first input operation is different from the second input operation.

In the above embodiment, the second input operation is a sliding operation. Said activating by the electronic device the first functional module in response to a timing trigger for the operation control comprises: obtaining a sliding operation on the operation control and starting a timer; displaying a slide trail corresponding to the sliding operation on the display unit; determining a timing period of the timer based on the length of the slide trail; causing the timer to start a countdown of the timing period when the sliding operation ends; and activating the first functional module upon completion of the countdown.

In the above embodiment, the operation control is located at a first position upon the timing trigger, and at a second position different from the first position when the sliding operation ends. The method further comprises: controlling the operation control to move from the second position to the first position when the sliding operation ends; and controlling the operation control to be located at the first location upon completion of the countdown.

In the above embodiment, the information processing method further comprises: obtaining a predetermined operation during the movement of the operation control from the second position to the first position; and controlling, in response to the predetermined operation, to switch from the timing trigger to the operating trigger for the operation control, while controlling the operation control to shift directly from its current position to the first position.

In the above embodiment, the information processing method further comprises: displaying an image captured by a capturing unit of the electronic device in a photographing application on the display unit of the electronic device along with the operation control; and storing, by the electronic device, the captured image in a storage unit of the electronic device in response to the operating trigger when the operation control is operating triggered by the first input operation, or in response to the timing trigger when the operation control is timing-triggered by the second input operation.

According to another embodiment of the present invention, an electronic device is provided. The electronic device comprises: a display unit configured to display an operation control; a first processing unit configured to activate a first functional module in response to an operating trigger for the operation control upon obtaining a first input operation on the operation control; and a second processing unit configured to activate the first functional module in response to a timing trigger for the operation control upon obtaining a second input operation on the operation control. The first input operation is different from the second input operation.

In the above embodiment, the second input operation is a sliding operation. The second processing unit comprises an obtaining and activating sub-unit and a determining sub-unit. The obtaining and activating sub-unit is configured to obtain a sliding operation on the operation control and start a timer. The display unit is configured to display a slide trail corresponding to the sliding operation. The determining sub-unit is configured to determine a length of the slide trail, determine a timing period of the timer based on the length of the slide trail, cause the timer to start a countdown of the timing period when the sliding operation ends, and activate the first functional module upon completion of the countdown.

In the above embodiment, the second processing unit further comprises a controlling sub-unit. The operation control is located at a first position upon the timing trigger and at a second position different from the first position when the sliding operation ends. The controlling sub-unit is configured to control the operation control to move from the second position to the first position when the sliding operation ends and control the operation control to be located at the first location upon completion of the countdown.

In the above embodiment, the controlling sub-unit is further configured to: obtain a predetermined operation during the movement of the operation control from the second position to the first position; and control, in response to the predetermined operation, to switch from the timing trigger to the operating trigger for the operation control, and control the operation control to shift directly from its current position to the first position.

In the above embodiment, the second processing unit further comprises a capturing sub-unit configured to capture an image. The electronic device further comprises a storage unit configured to store an image. The display unit is configured to display the captured image along with the operation control. The electronic device stores the captured image in the storage unit when the operation control is operating-triggered by the first input operation, or when the operation control is timing triggered by the second input operation.

With the information processing method and the electronic device according to the embodiments of the present invention, an operation control for activating a first functional module is displayed on a display unit of the electronic device. The electronic device activates the first functional module in response to an operating trigger for the operation control upon obtaining a first input operation on the operation control. The electronic device activates the first functional module in response to a timing trigger for the operation control upon obtaining a second input operation on the operation control. The first input operation is different from the second input operation. With the solutions of the present invention, there is no need in a photographing or playing application to set operation steps of the application, and a countdown function of the application can be achieved by simply sliding the operation control, thereby saving time and labor. Further, the countdown of timing period can be displayed in the form of the length of the slide trail. Hence, the user can be aware of the particular time instant at which a photographing or playing operation will occur or the time instant at which it is counted down to zero.

### BRIEF DESCRIPTION OF THE DRAWINGS

FIG. 1 is a flowchart of an information processing method according to an embodiment of the present invention;

FIGS. 2(a)-2(c) are flowcharts illustrating an information processing method according to an embodiment of the present invention;

FIGS. 3(a)-3(c) are flowcharts illustrating an information processing method according to another embodiment of the present invention;

FIG. 4 is a schematic block diagram of an electronic device according to an embodiment of the present invention; and

FIG. 5 is a schematic block diagram of a second processing unit according to an embodiment of the present invention.

### DETAILED DESCRIPTION OF THE EMBODIMENTS

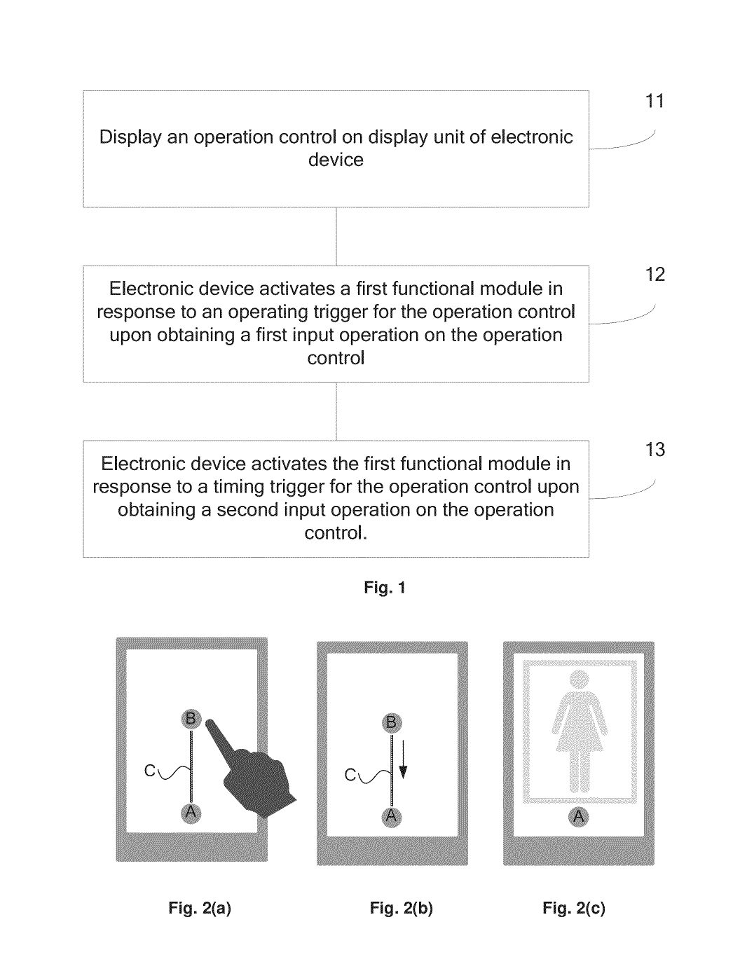

According to an embodiment of the present invention, an information processing method is provided. The information processing method is applied in an electronic device having a display unit. As shown in FIG. 1, the method includes the following steps.

At step 11, an operation control for activating a first functional module is displayed on the display unit of the electronic device.

Here, the display unit may be a display screen, and the operation control may be implemented as a functional key on the display screen of the electronic device. The first functional module may be a photographing module, a player having a time countdown function, a module having a timing function (e.g., an alarm) or a module having a time countdown function (e.g., a countdown stopwatch).

At step 12, the electronic device activates the first functional module in response to an operating trigger for the operation control upon obtaining a first input operation on the operation control.

Here, the first input operation may include a single-click, a double-click or a predetermined number of clicks on the operation control.

In this step, when the electronic device activates a photographing application, an image captured by a capturing unit of the electronic device may be displayed on the display unit of the electronic device along with the operation control. The electronic device may store the captured image in a storage unit of the electronic device in response to the operating trigger when the operation control is operating-triggered by the first input operation.

Here, the storage unit may be a Random Access Memory (RAM), a Secure Digital (SD) memory card or the like.

This step can be explained with reference to an example in which the first input operation is a click and the first function module is a photographing module. Upon detecting that the operation control is single clicked, the electronic device activates the photographing module for photographing. The capturing unit of the electronic device captures an image of a current scene and the display unit displays the captured image along with the operation control. Here, the operation control and the captured image may be displayed in an overlapped manner. In contrast to the prior art where a number of setting steps are required before photographing, according to the embodiment of the present invention, the user only needs to perform an operation such as single click or double click on the operation control before photographing. In this way, the setting steps can be simplified and time and labor can be saved.

At step 13, the electronic device activates the first functional module in response to a timing trigger for the operation control upon obtaining a second input operation on the operation control.

Here, the second input operation may include single clicking and moving the operation control, double clicking and moving the operation control, or clicking the operation control for a predetermined number of times and moving the operation control. The first input operation is different from the second input operation.

It is to be noted here that, with the embodiment of the present invention, when a user wants to uses a photographing application or a music/video/ringtone playing application, two application modes may be provided: a mode based on operating trigger and a mode based on timing trigger.

Further, the electronic device obtains a sliding operation on the operation control, and starts a timer. A slide trail corresponding to the sliding operation is displayed on the display unit. A timing period of the timer is determined based on the length of the slide trail. The timer is caused to start a countdown of the timing period when the sliding operation ends.

Here, the position where the operation control is located when it is timing-trigger is referred to as a first position of the operation control. The user single clicks the operation control at the first position and slides it in a predetermined direction. At the same time, the slide trail corresponding to the sliding operation is displayed on the display screen. The position where the operation control is located when the sliding operation ends is referred to as a second position of the sliding operation. The second position is different from the first position of the operation control. The length of the slide trail is proportional to the timing period of the timer. The electronic device obtains the sliding operation, determines the length of the slide trail corresponding to the sliding operation and the timing period corresponding to the length of the slide trail, and activates a timer to start a countdown of the timing period when the sliding operation ends. During the countdown of the timing period by the timer, the electronic device controls the operation control to move from the second position to the first position, and controls the operation control to be located at the first location upon completion of the countdown of the timing period.

Here, the proportional relationship between the length of the slide trail and the timing period may be linear or nonlinear, and such relationship may be preconfigured in the electronic device.

During the movement of the operation control from the second position to the first position, i.e., during the countdown of the timing period by the timer, the electronic device controls to switch from the timing trigger to the operating trigger for the operation control upon obtaining a predetermined operation on the electronic device (e.g., shaking the electronic device, or clicking on the moving operation control). At the same time, the timer stops the countdown, and the electronic device controls the operation control to shift from its current position directly to the first position.

Here, the slide trail may be a straight line or a curved line.

In the case where a photographing application is activated by the electronic device, the capturing unit (e.g., a camera) of the electronic device captures an image upon completion of the countdown of the timing period. The captured image and the operation control may be displayed together on the display screen. The electronic device may store the image captured by the capturing unit in the storage unit of the electronic device in response to the timing trigger for the operation control.

### First Embodiment

FIGS. 2(a)-2(c) are flowcharts illustrating implementation of step 13 according to an embodiment of the present invention. In the following, the solution according to the embodiment of the present invention will be further explained with reference to FIGS. 2(a)-2(c) and in connection with an example where the electronic device (e.g., a smart phone) activates a photographing function, the sliding operation is a dragging operation, and the length of the slide trail corresponding to the sliding operation is linearly proportional to the timing period of the timer.

As shown in FIG. 2(a), an operation control is displayed on an operation interface of a photographing application on the display screen. The operation control is located at a position A, referred to as the first position. The user uses his/her finger to single click the operation control and drag it from the first position along the longitudinal direction of the smart phone on the operation interface. Upon detecting the dragging operation, the smart phone activates the photographing function in response to the dragging operation. When the user's finger leaves the display screen thereby completing the dragging operation, the operation control is located at a position B, referred to as the second position. A dragging trail C as straight line produced during the dragging operation has a length of 5 cm, which corresponds to a timing period of 5 seconds of the timer in the smart phone. When the operation control is dragged to the second position, the timer starts a countdown of 5 s.

As shown in FIG. 2(b), during the countdown of 5 s by the timer, the operation control moves from the second position to the first position. Accordingly, the user can recognize the particular time instant at which he/she will be photographed and thus adjust his/her pose before that time instant.

As shown in FIG. 2(c), upon completion of the countdown of the timing period 5 s, the operation control slides back to the first position, i.e., the position A. At this time, the camera of the electronic device photographs the current scene and the resulting photo is displayed on the display screen along with the operation control.

In this embodiment, during the countdown of 5 s by the timer, if the smart phone detects that the electronic device is shaken, it controls to switch from the timing trigger to the operating trigger for the operation control. At the same time, the electronic device controls the timer to stop the countdown and controls the operation control to shift from its current position in the dragging trail directly to the first position, i.e., back to the position A.

### Second Embodiment

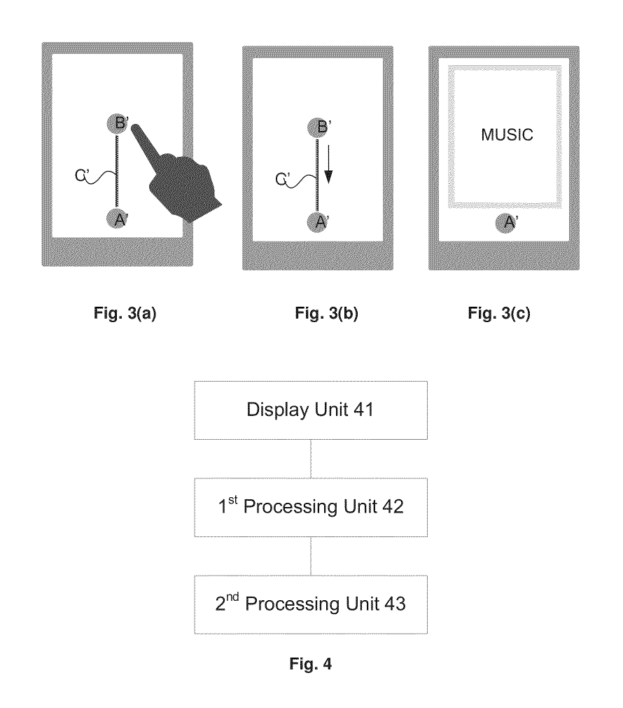

FIGS. 3(a)-3(c) are flowcharts illustrating implementation of step 13 according to another embodiment of the present invention. In the following, the solution according to the embodiment of the present invention will be further explained with reference to FIGS. 3(a)-3(c) and in connection with an example where the electronic device (e.g., a smart phone) activates a player, the sliding operation is a dragging operation, and the length of the slide trail corresponding to the sliding operation is linearly proportional to the timing period of the timer.

This embodiment may be applied in a scenario where the user wants to play a piece of music in 10 seconds. The solution according to this embodiment may be utilized to achieve a timing-based playing function for the player.

In particular, as shown in FIG. 3(a), an operation interface of the player is displayed on the display screen, and an operation control is displayed on the operation interface. The operation control is currently located at a position A′, referred to as the first position. When the user wants to use a playing function with time countdown, he/she uses his/her finger to single click the operation control and drag it from the first position along the longitudinal direction of the smart phone. The distance by which the operation control is dragged corresponds to the timing period of a timer for the player.

Upon detecting the dragging operation, the smart phone activates the time countdown function in response to the dragging operation. The user drags the operation control from the first position to the second position. Here, the second position is the position B′ where the operation control is located when the dragging operation ends.

A dragging trail as a straight line C′ produced when the user drags the operation control has a length of 8 cm, which corresponds to a timing period of 10 s of the timer. When the dragging operation ends, i.e., when the operation control is dragged to the second position, the player timer starts a countdown of 10 s.

As shown in FIG. 3(b), during the countdown of 10 s by the timer, the smart phone controls the operation control to move from the second position to the first position. As shown in FIG. 3(c), upon completion of the countdown of the timing period of 10 s by the timer, the operation control slides back to the first position, i.e., the position A′.

During the countdown by the timer, if the user considers that the countdown timing period is too short or too long, and wants to terminate the countdown, he/she may perform a predetermined operation by shaking the smart phone. Upon detecting this operation, the smart phone controls the timer to stop the countdown, controls to switch from the timing trigger to the operating trigger for the operation control, and controls the operation control to slide from its current position in the dragging trail back to the position A′.

Based on the above information processing method, an embodiment of the present invention also provides an electronic device. As shown in FIG. 4, the device includes a display unit 41, a first processing unit 42 and a second processing unit 43.

The display unit 41 is configured to display an operation control.

The first processing unit 42 is configured to activate a first functional module in response to an operating trigger for the operation control upon obtaining a first input operation on the operation control.

The second processing unit 43 is configured to activate the first functional module in response to a timing trigger for the operation control upon obtaining a second input operation on the operation control.

The operation control is used to activate the first functional module. The first input operation is different from the second input operation.

Here, the display unit 41 may be a display screen, and the operation control may be implemented as a functional key on the display screen of the electronic device. The first functional module may be a photographing module, a player having a time countdown function, a module having a timing function (e.g., an alarm) or a module having a time countdown function (e.g., a countdown stopwatch).

The first input operation may include a single-click, a double-click or a predetermined number of clicks on the operation control. The second input operation may include single clicking and moving the operation control, double clicking and moving the operation control, or clicking the operation control for a predetermined number of times and moving the operation control. The first input operation is different from the second input operation.

When the first processing unit 42 activates a photographing application, an image captured by a capturing unit (e.g. a camera) of the first processing unit 42 may be displayed on the display unit of the electronic device along with the operation control. The electronic device may store the captured image in a storage unit of the electronic device in response to the operating trigger when the operation control is operating-triggered by the first input operation.

Here, the storage unit may be a RAM, a SD memory card or the like.

The function of the first processing unit 42 may be explained with reference to an example in which the first input operation is a click, and the first function module is a photographing module. Upon detecting that the operation control is single clicked, the first processing unit 42 activates the photographing module for photographing. The capturing unit (e.g., a camera) of the first processing unit 42 captures an image of a current scene and the display unit 41 displays the image captured by the capturing unit along with the operation control. In contrast to the prior art where a number of setting steps are required before photographing, according to the embodiment of the present invention, the user only needs to perform an operation such as single-click or double click on the operation control before photographing. In this way, the setting steps can be simplified and time and labor can be saved.

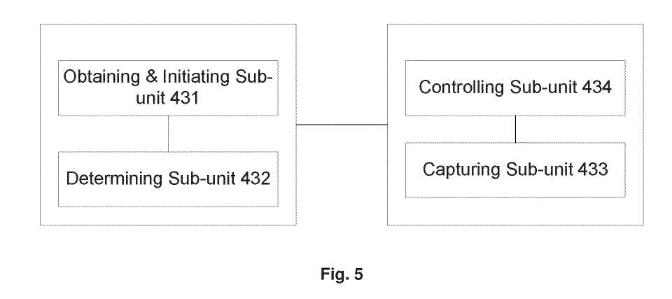

As shown in FIG. 5, the second processing unit 43 includes an obtaining and activating sub-unit 431 and a determining sub-unit 432.

The obtaining and activating sub-unit 431 is configured to obtain a sliding operation on the operation control and start a timer.

The display unit 41 is configured to display a slide trail corresponding to the sliding operation.

The determining sub-unit 432 is configured to determine a length of the slide trail, determine a timing period of the timer based on the length of the slide trail, cause the timer to start a countdown of the timing period when the sliding operation ends, and activate the first functional module upon completion of the countdown of the timing period.

Here, the slide trail may be a straight line or a curve. The proportional relationship between the length of the slide trail and the timing period may be linear or nonlinear, and such relationship may be preconfigured in the determining sub-unit 432.

The second processing unit 43 further includes a capturing sub-unit 433 and a controlling sub-unit 434.

When the electronic device activates a photographing application, the capturing sub-unit 433 is configured to capture an image. The display unit 41 is configured to display the image captured by the capturing sub-unit 433 along with the operation control.

Accordingly, the image captured by the capturing sub-unit 433 is stored in response to the operation control being timing-triggered.

The operation control is located at a first position upon occurrence of the timing trigger, and at a second position different from the first position when the sliding operation ends.

The controlling sub-unit 434 is configured to control the operation control to move from the second position to the first position when the sliding operation ends, and control the operation control to be located at the first location upon completion of the countdown of the timing period.

The controlling sub-unit 434 is further configured to: obtain a predetermined operation during the movement of the operation control from the second position to the first position; and control, in response to the predetermined operation, to switch from the timing trigger to the operating trigger for the operation control, and control the operation control to shift directly from its current position to the first position.

Here the predetermined operation may include e.g., shaking the electronic device, or clicking on the moving operation control.

In particular, when the operation control is located at a first position, the obtaining and activating sub-unit 431 detects that the user single clicks the operation control and slides it in a predetermined direction to a second position different from the first position. The obtaining and activating sub-unit 431 obtains the sliding operation and starts a timer when the sliding operation ends. At the same time, the display unit 41 displays the slide trail corresponding to the sliding operation. The length of the slide trail is proportional to the timing period of the timer started by the obtaining and activating sub-unit 431.

The determining sub-unit 432 first determines the length of the slide trail corresponding to the users sliding operation on the operation control. Since the proportional relationship between the length of the slide trail and the timing period is preconfigured, the determining sub-unit 432 may determine the timing period corresponding to the length of the slide trail based on this proportional relationship, and activate the timer to start a countdown of the timing period when the sliding operation ends.

During the countdown of the timing period by the timer, the controlling sub-unit 434 controls the operation control to move from the second position to the first position, and controls the operation control to be located at the first location upon completion of the countdown of the timing period. During this process, upon obtaining a predetermined operation on the electronic device (e.g., shaking the electronic device), the controlling sub-unit 434 controls to switch from the timing trigger to the operating trigger for the operation control, controls the timer to stop the countdown of the timing period, and controls the operation control to shift from its current position in the slide trail directly to the first position.

The determining sub-unit 432 activates the first functional module (e.g., a photographing module) upon determining that the countdown of the timing period is completed. The image captured by the capturing sub-unit 433 is displayed on the display unit 41 along with the operation control. The second processing unit 43 stores the image captured by the capturing sub-unit 433 in the storage unit in response to the timing trigger for the operation control.

Application Scenario I

In the following, the solution according to the embodiment of the present invention will be further explained with reference to FIGS. 2(a)-2(c) and in connection with an example where the electronic device (e.g., a smart phone) activates a photographing function, the sliding operation is a dragging operation, and the length of the slide trail corresponding to the sliding operation is linearly proportional to the timing period of the timer.

As shown in FIG. 2(a), an operation control is displayed on an operation interface of a photographing application on the display unit 41. The operation control is located at a position A, referred to as the first position. The user uses his/her finger to click the operation control and drag it from the first position along the longitudinal direction of the smart phone on the display unit 41. Upon detecting the trigger operation, the obtaining and activating sub-unit 431 activates the photographing function in response to the trigger operation. When the user's finger leaves the display unit 41 thereby completing the dragging operation, the operation control is located at a position B, referred to as the second position. The obtaining and activating sub-unit 431 obtains the dragging operation, and starts a timer when the dragging operation ends. Here, the dragging operation corresponds to a dragging trail as a straight line C having a length of 5 cm. The determining sub-unit 432 determines that the dragging trail C having a length of 5 cm corresponds to a timing period of 5 s of the timer, and triggers the timer to start a countdown of 5 s upon determining that the dragging operation ends.

As shown in FIG. 2(b), when the dragging operation ends, the controlling sub-unit 434 controls the operation control to move from the second position to the first position.

As shown in FIG. 2(c), upon completion of the countdown of the timing period of 5 s, the controlling sub-unit 434 controls the operation control to slide back to the first position, i.e., the position A. At this time, the capturing sub-unit 433 (which may be a camera in particular) photographs the current scene, and the resulting photo is displayed on the display unit 41 along with the operation control. With the movement of the operation control from the second position to the first position, the user can recognize the particular time instant at which he/she will be photographed and can adjust his/her pose before that time instant.

In this embodiment, during the countdown of 5 s by the timer, if the controlling sub-unit 434 detects a predetermined operation on the electronic device, i.e., the electronic device is shaken, it controls the timer to stop the countdown, controls to switch from the timing trigger to the operating trigger for the operation control, and controls the operation control to slide from its current position in the dragging trail directly back to the position A.

Application Scenario II

In the following, the solution according to the embodiment of the present invention will be further explained with reference to FIGS. 3(a)-3(c) and in connection with an example where the electronic device (e.g., a smart phone) activates a player, the sliding operation is a dragging operation, and the length of the slide trail corresponding to the sliding operation is linearly proportional to the timing period of the timer.

As shown in FIG. 3(a), an operation control is displayed on an operation interface of a player application on the display unit 41. The operation control is currently located at a position A′, referred to as a first position. When the user wants to use a timing-based music playing application, he/she uses his/her finger to click the operation control and drag it along the longitudinal direction of the smart phone. Upon detecting the trigger operation, the obtaining and activating sub-unit 431 activates the time countdown function of the player in response to the trigger operation. The user drags the operation control from the first position to a second position. Here the second position is the position B′ where the operation control is located when the dragging operation ends.

The obtaining and activating sub-unit 431 obtains the dragging operation and activates a player timer when the dragging operation ends. The determining sub-unit 432 determines that the dragging operation corresponds to a dragging trail line C′ having a length of 5 cm, which corresponds to a timing period of 10 s of the player timer. Upon determining that the dragging operation ends, i.e., when the operation control is dragged to the second position, the determining sub-unit 432 triggers the player timer to start a countdown of 10 s.

As shown in FIG. 3(b), during the countdown of 10 s by the player timer, the controlling sub-unit 434 controls the operation control to move from the second position to the first position. As shown in FIG. 3(c), upon completion of the countdown of the timing period of 10 s by the player timer, the operation control slides back to the first position, i.e., the position A′.

In this embodiment, when the operation control moves from the second position to the first position, the user may be aware of the particular time at which the countdown will be completed. During this time period, if the user considers that the countdown timing period of the player timer is too short or too long and wants to terminate the countdown, he/she may shake the smart phone. Upon detecting this predetermined operation, the controlling sub-unit 434 controls to switch from the current timing trigger to the operating trigger for the operation control, controls the player timer to stop the current countdown, and controls the operation control to slide from its current position in the dragging trail back to the position A′.

With the information processing method and the electronic device according to the embodiments of the present invention, an operation control for activating a first functional module is displayed on a display unit of the electronic device. The electronic device activates the first functional module in response to an operating trigger for the operation control upon obtaining a first input operation on the operation control. The electronic device activates the first functional module in response to a timing trigger for the operation control upon obtaining a second input operation on the operation control. The first input operation is different from the second input operation. The solutions according to the embodiments of the present invention may be applied in a photographing application or a player application and provide a mode based on operating trigger and a mode based on timing trigger. In a photographing or playing application with time countdown function, it is possible to achieve an immediate or timing-based photographing operation. Compared with the prior art, the setting of the photographing or playing steps can be simplified, thereby saving time and effort. Further, the time countdown of the photographing or playing operation can be seen by the user, such that the user can adjust his/her pose during the time countdown, thereby avoiding capturing an unexpected photo.

It can be appreciated from the embodiments of the present application that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present invention.

Further, all the functional units in various embodiments of the present invention can be integrated within one processing unit, or each of these units can be a separate unit, or two or more units can be integrated into one unit. Such integrated unit can be implemented in hardware, possibly in combination with software functional units.

It can be appreciated by those skilled in the art that some or all of the steps in the method embodiment as described above can be implemented by hardware following instructions of a program. Such program can be stored in a computer readable storage medium and, when executed, performs the steps of the above method embodiment. The storage medium may be any of various mediums capable of storing program codes, such as a mobile storage device, a Read Only Memory (ROM), a Random Access Memory (RAM), a magnetic disk or an optical disc.

While the embodiments of the present invention have been described above, the scope of the present invention is not limited thereto. Various modifications and alternatives can be made by those skilled in the art without departing from the scope of the present disclosure. These modifications and alternatives are to be encompassed by the scope of the present invention which is only defined by the claims as attached.

What is claimed is:

1. An information processing method in an electronic device, comprising:
displaying an operation control for activating a first functional module on a display unit of the electronic device;
activating, by the electronic device, the first functional module in response to an operating trigger for the operation control upon obtaining a first input operation on the operation control; and
activating, by the electronic device, the first functional module in response to a timing trigger for the operation control upon obtaining a second input operation on the operation control,
wherein the first input operation is different from the second input operation.

2. The method of claim 1, wherein the second input operation is a sliding operation, and said activating by the electronic device the first functional module in response to a timing trigger for the operation control comprises:
obtaining a sliding operation on the operation control, and starting a timer;
displaying a slide trail corresponding to the sliding operation on the display unit;
determining a timing period of the timer based on the length of the slide trail;
causing the timer to start a countdown of the timing period when the sliding operation ends; and
activating the first functional module upon completion of the countdown.

3. The method of claim 2, wherein the operation control is located at a first position upon the timing trigger, and at a second position different from the first position when the sliding operation ends, and
the method further comprises:
controlling the operation control to move from the second position to the first position when the sliding operation ends; and
controlling the operation control to be located at the first location upon completion of the countdown.

4. The method of claim 3, further comprising:
obtaining a predetermined operation during the movement of the operation control from the second position to the first position; and
controlling, in response to the predetermined operation, to switch from the timing trigger to the operating trigger for the operation control, while controlling the operation control to shift directly from its current position to the first position.

5. The method of claim 1, further comprising:
displaying an image captured by a capturing unit of the electronic device in a photographing application on the display unit of the electronic device along with the operation control; and
storing, by the electronic device, the captured image in a storage unit of the electronic device in response to the operating trigger when the operation control is operating-triggered by the first input operation, or in response to the timing trigger when the operation control is timing-trigger by the second input operation.

6. An electronic device, comprising:
a display unit configured to display an operation control;
a first processing unit configured to activate a first functional module in response to an operating trigger for the operation control upon obtaining a first input operation on the operation control; and
a second processing unit configured to activate the first functional module in response to a timing trigger for the operation control upon obtaining a second input operation on the operation control,
wherein the first input operation is different from the second input operation.

7. The electronic device of claim 6, wherein the second input operation is a sliding operation, and the second processing unit comprises an obtaining and activating sub-unit, and a determining sub-unit, and wherein
the obtaining and activating sub-unit is configured to obtain a sliding operation on the operation control and start a timer;
the display unit is configured to display a slide trail corresponding to the sliding operation;
the determining sub-unit is configured to determine a length of the slide trail, determine a timing period of the timer based on the length of the slide trail, cause the timer to start a countdown of the timing period when the sliding operation ends, and activate the first functional module upon completion of the countdown.

8. The electronic device of claim 7, wherein the second processing unit further comprises a controlling sub-unit,
the operation control is located at a first position upon the timing trigger, and at a second position different from the first position when the sliding operation ends, and
the controlling sub-unit is configured to control the operation control to move from the second position to the first position when the sliding operation ends, and control the operation control to be located at the first location upon completion of the countdown.

9. The electronic device of claim 8, wherein the controlling sub-unit is further configured to:
obtain a predetermined operation during the movement of the operation control from the second position to the first position; and
control, in response to the predetermined operation, to switch from the timing trigger to the operating trigger for the operation control, and control the operation control to shift directly from its current position to the first position.

10. The electronic device of claim 6, wherein the second processing unit further comprises a capturing sub-unit configured to capture an image,
the electronic device further comprises a storage unit configured to store an image,
the display unit is configured to display the captured image along with the operation control, and
the electronic device stores the captured image in the storage unit when the operation control is operating-triggered by the first input operation, or when the operation control is timing-triggered by the second input operation.
